(19) United States
(12) Patent Application Publication
(10) Pub. No.: US 2025/0028968 A1
(43) Pub. Date: Jan. 23, 2025

(54) CONTROLLING A SWARM OF AGENTS

(71) Applicant: BAE SYSTEMS PLC, London (GB)

(72) Inventor: Marc Espinós Longa, Bedford Bedfordshire (GB)

(73) Assignee: BAE SYSTEMS PLC, London (GB)

(21) Appl. No.: 18/711,192

(22) PCT Filed: Nov. 17, 2022
(86) PCT No.: PCT/GB2022/052920

§ 371 Date: May 17, 2024

(30) Foreign Application Priority Data
Nov. 18, 2021 (GB) 2116649.1

(51) Int. Cl. G06N 3/092

(52) U.S. Cl. CPC G06N 3/092

(57) ABSTRACT

Embodiments provide a computer-implemented method of controlling a swarm of agents to perform actions, and agents configured accordingly. The method comprises providing (202) data for performing Reinforcement Learning in each agent in the swarm. Each of the agents uses the provided data to execute (204) at least one learning episode to train a respective state-action selector, and uses its trained state-action selector to select and perform an action (220). The training comprises each of the agents using its respective state-action selector to select (306) a fictitious action it would perform itself in the current joint states and to select a fictitious action the other agents would perform in the current joint states, and using the selected fictitious actions to update (308-312, 208-216) values in the state-action selector of each of the agents.

The present invention relates to controlling a swarm of agents.

Machine Learning (ML) and related techniques are widely used for a variety of applications, including controlling devices, such as autonomous vehicles and robots. Known techniques include swarm intelligence, where a set, or “swarm”, of agents can interact with each other and their environment. The agents follow simple rules without a centralized control structure.

Reinforcement Learning (RL) tree-based planning methods have been gaining popularity in the last few years due to their success in single-agent domains, where a perfect simulator model is available, e.g. Go and chess strategic board games. However, single-agent solutions may not be effective in some cases. For instance, in a situation where a swarm of unmanned autonomous vehicles (UAVs) need to cover a large area and/or time-limited scenarios, such as an exploration, 3D mapping, surveillance or search-and-rescue, single-agent processing can prove ineffective. Cases where a large number of agents are used, or need to be deployed quickly, can also be unsuitable for single-agent solutions.

Addressing single-agent and multi-agent domains often entails partial or no information about the boundary conditions and a high degree of uncertainty. Thus, the problem becomes untreatable through input/output driven data structures. Moreover, the inherent complexity demands feedback to solve and optimize the problem, i.e. unsupervised techniques are usually not enough. Reward-based learning has demonstrated to be a natural fit in this area due to the capability of generating unique solutions with reinforcements and data restrictions.

RL uses value functions under a Markov Decision Process (MDP) framework, considering every state and action taken at every iteration step. This fact often leads to rigorous policies that, despite the increasing demand of computational resources, achieve greater performance in large search spaces. When training agents under an MDP, the RL spectrum encompasses many design aspects that can be explored. From one-step updates in sample temporal-difference (TD) methods to n-step algorithms that wait a variable or fixed number of MDP transitions before recomputing state-action values. As a result of bootstrapping (estimates as a function of future value estimates), TD strategies provide faster learning rates at the penalty of higher bias. In contrast, Monte Carlo methods, which are the most extreme form of n-step algorithms, delay updates until the end of the episode, removing any bias and significantly increasing the variance of the optimization process.

Forward Planning is another powerful tool for speeding up learning by alternating direct RL updates from real-world interactions with simulated trajectories (model-based methods), which can be derived from agent experience using replay buffers or already-built environment models. Forward planning through an existing model can be used to make predictions and optimize action selection mechanisms.

Transitioning from single-agent to multi-agent framework is no trivial task. Even from a team learning perspective where agents are treated as a master individual and single-agent techniques apply, problems emerge related to enormous state spaces (curse of dimensionality problem) that grow exponentially to the number of agents. Furthermore, like any other centralized system, team learning requests full swarm connectivity and is reliant on a critical leading node. On the other hand, concurrent learning utilizes a distributed network of agents to handle multiple learning processes simultaneously. Thus, co-adaption through reinforcements is required to achieve optimal cooperation. The credit assignment problem involves allocating efficient incentives to individuals and remains a difficult endeavour in the Multi-Agent Reinforcement Learning (MARL) problem. Similarly, communication is crucial to enhance the learning process. However, in some situations and environments reliable communications is not always available.

Embodiments of the present invention are intended to address at least some of the above technical problems.

Embodiments may be based on an awareness that there is some implicit uncertainty and that there is no natural model available to predict and hence carry out simulated forward planning. Embodiments can therefore create a model that minimises the environment uncertainty by making environment predictions. This model can comprise a neural network that has been trained to minimise the problem uncertainty so that the forward planning can be carried out effectively (in contrast to existing model-game environments where perfect models are available, or where the state space fully relies on the agent's actions). Hence, embodiments can boost model sampling, which may lead to better agent learning, i.e., model learning inference can improve the quality of agent planning and so learning is enhanced.

Embodiments can extend tree search algorithms to a multi-agent setting in a decentralized structure, dealing with scalability issues and exponential growth of computational resources. Embodiments can use what is termed the N-Step Dynamic Tree Search (NSDTS), which combines forward planning and direct RL/temporal-difference updates. Embodiments can markedly outperform state-of-the-art algorithms such as Q-Learning and SARSA. In embodiments future state transitions and rewards can be predicted with a model built and learned from real interactions between agents and the environment. In embodiments action selection mechanisms can be improved by using a neural network model built from real-world experience to perform forward tree search. For system robustness, communication can be disregarded and individual agents can assume best play of agents to carry out future predictions. Expected updates can be utilized to weight state-action value estimates that are kept in individual Q tables (for tabular settings), and agents can be reinforced with hybrid rewards (individual and global incentives).

According to one aspect of the present invention there is provided a (computer-implemented) method of controlling a swarm of agents to perform actions, the method comprising:
providing data for performing Reinforcement Learning in each agent in the swarm;
each of the agents in the swarm using the provided data to execute at least one learning episode to train a respective state-action selector in each of the agents in the swarm, wherein the state-action selector is configured to select an action based on joint states of the agents in the swarm, and
each of the agents in the swarm using its respective trained state-action selector to select and perform an action,
wherein the training of the respective state-action selector in each of the agents in the swarm comprises:
each of the agents in the swarm using its respective state-action selector to select a fictitious action it would perform itself in the current joint states and to select a fictitious action the other agents in the swarm would perform in the current joint states, and
using the selected fictitious actions to update values in the state-action selector of each of the agents in the swarm.

The Reinforcement Learning may comprise a Markov Decision Process, MDP. The provided data can include data for performing the MDP and may comprise:
the state-action selector;
a policy for determining how to use the state-action selector to select the action based on the joint state of the agents;
a probabilistic behaviour model configured to predict a next state of an environment based on a current state of the environment, and
an environment model configured to generate a set of next joint states of the agents and rewards, based on the current state of the environment, a current joint states of the agents, and current actions of the agents in the swarm.

The state-action selector may comprise a state-action value table. Alternatively, in function approximation embodiments, the state-action selector may comprise a state-action function.

The training of the respective state-action selector in each of the agents in the swarm may comprise:
using the probabilistic behaviour model to (partially) predict the next state of the environment;
using the environment model to generate a next reward and a next joint states transition based on the predicted next state of the environment, and
storing an MDP sequence comprising the selected fictitious actions, the next reward and the next joint state transition.

The training steps may be repeated until step N is reached, or when terminal joint states are reached. The method may then comprise computing RL returns and updating state-action values back to an initial planning step (real current time step).

The method may further comprise:
each of the agents in the swarm using its respective policy and state-action selector to select an action to perform in the real environment;
transitioning the real environment to a next state, providing a corresponding reward to each of the agents in the swarm, and storing an MDP sequence to (directly) update values in the state-action selectors, and
each of the agents in the swarm using the stored MDP sequence to update values in its respective state-action selector.

At least some of the training steps may be repeated by every said agent in the swarm.

The policy may comprise an E-greedy policy.

The agents may not perform inter-agent communication, but can have full MDP observability.

The probabilistic behaviour model may comprise an artificial neural network further configured to predict next actions of non-controllable items/features (e.g. an enemy UAV that is being tracked) in the environment given the current joint states. The artificial neural network may function as a classifier that receives as input MDP states and outputs action classes. Error of prediction of the artificial neural network can be computed using a cross entropy function. Optimization of the artificial neural network can be implemented via backpropagation, e.g. using ADAM.

According to another aspect of the present invention there is provided an (autonomous) agent apparatus configured to:
receive data for performing Reinforcement Learning in the agent;
use the provided data to execute at least one learning episode to train a respective state-action selector, wherein the state-action selector is configured to select an action based on joint states of a plurality of agents in a swarm, and
use the trained state-action selector to select and perform an action,
wherein the training of the respective state-action selector comprises:
using the state-action selector to select a fictitious action the agent would perform itself in the current joint states and to select a fictitious action the other agents in the swarm would perform in the current joint states, and
use the selected fictitious actions to update values in the state-action selector.

The agent may be comprised in/on, or associated with, a vehicle capable of autonomous behaviour, or a robot.

According to another aspect of the present invention there is provided a swarm comprising a plurality of agents substantially as described herein.

Another to another aspect there is provided a system comprising the swarm of agents and at least one further computing device.

According to another aspect of the present invention there is provided a method of training a RL data structure substantially as described herein.

According to another aspect of the present invention there is provided a method of training an artificial neural network substantially as described herein.

According to another aspect there is provided a computer program product comprising instructions which, when the program is executed by a computer, cause the computer to carry out methods substantially as described herein.

According to other aspects of the present invention there is provided a computer device/agent apparatus configured to execute a method substantially as described herein.

### BRIEF DESCRIPTION OF THE FIGURES

For a better understanding of the invention, and to show how embodiments of the same may be carried into effect, reference will now be made, by way of example, to the accompanying diagrammatic drawings in which:

FIG. 1 is a block diagram of an example system comprising a swarm of agents;

FIG. 2 is a flowchart illustrating steps performed by the agents in an embodiment;

FIG. 3 is a flowchart detailing steps performed during a forward planning routine of the embodiment;

FIG. 4 shows an algorithm used as the basis for implementing some embodiments;

FIG. 5 discloses an example architecture of the system;

FIG. 6 schematically illustrates the Hunter-Prey pursuit problem to which the algorithm can be applied, and

FIGS. 7A-7B comprise graphs comparing performance of an embodiment with known techniques.

### DETAILED DESCRIPTION OF THE FIGURES

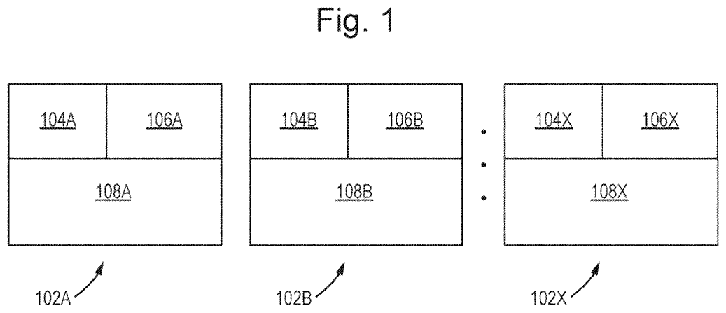

FIG. 1 is a block diagram of an example system 100 comprising a plurality of agents 102A, 102B, . . . , 102X. It will be understood that the illustrated number, arrangement and types of agents are exemplary only, and “X” can be any practical number greater than one. In general, each agent 102 can comprise (or be associated with) a computing device having at least one processor 104 and internal memory 106 (e.g. Random Access Memory). The internal memory 106 can store data and instructions for processing by the processor 104. Each agent can also have an interface module 108 that comprises one or more wired/wireless interface for communication with other agents. An interface may also be used to communicate, e.g. send control signals, to one or more components associated with the agent, such as a controller for a vehicle or robot. Each agent may also include (or be associated with) further conventional features, such as non-volatile storage, power source, and so on, which need not be described herein in detail.

In some embodiments each agent 102 is comprised in/on, or associated with, an autonomous vehicle. It may be a land, air or water-based vehicle. The autonomous vehicle may be used for various applications, e.g. consumer, industrial or military purposes. The autonomous vehicle may be fully autonomous, or only some of its control/functionality may be autonomous, e.g. as selected by an onboard or remote human operator. In other embodiments each agent may associated with a robot, e.g. for manufacturing applications. Other applications include optimisation of complex systems, such as engines or any system whose functioning allows a division of itself into intelligent, decentralised and individual parts.

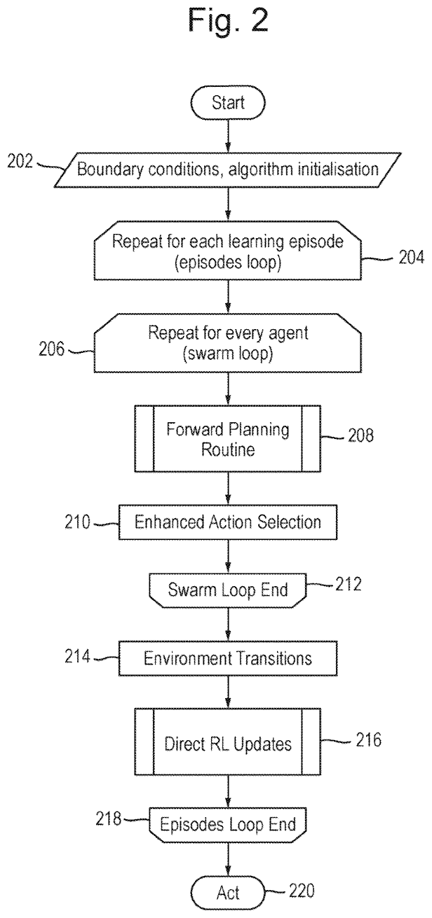

FIG. 2 shows steps performed by an agent 102 according to an embodiment. Each agent in the swarm may perform the steps whilst being in communication with other agents in the swarm and/or another computing device that can transfer data regarding the states of the other agents. Step 202 represents input parameters and initialisation. The MDP formulation can be defined, which may include, for example: the size of the swarm (number of learning agents), executable actions for each agent (which may be discrete or continuous) and state space representation. For a given set of heterogeneous autonomous vehicles, examples of continuous actions can include: heading control, throttle, elevator and/or rudder deflections, etc. Examples of discrete actions include: release payload, activate Auxiliary Power Unit (APU), use transponder, adopt certain cruise speed, manoeuvre at certain turn rate, stop engines, etc. The state space representation can depend on the application and environment, and can range from 2D grid-world finite environments to 3D continuous and infinite spaces.

Some embodiments are based on a tabular setting, i.e. the environment involves a finite set of states and actions. Other embodiments based on continuous actions and environments are possible, which require function approximation (such as Neural Networks) to build a virtual representation of the world in each agent. However, the Multi-Agent Reinforcement Learning (MARL) algorithm dynamics remains the same, independently of the state-action representation method.

For the tabular setting embodiments, state-action value tables are initialised for each agent, i.e. data tables containing all MDP possible states. In the function approximation embodiments, state-action functions are initialised. A probabilistic behaviour model (forward planning engine) and an environment model are also booted at step 202. The probabilistic behaviour model oversees next environment adjustments (partial non-controllable environment dynamics), given a set of joint states. For instance, if a UAV is being persecuted, the probabilistic behaviour model predicts the next UAV move given the current situation (it should be understood that the persecuted UAV is not under agent control and is not considered part of the swarm, but instead belongs to the environment dynamics). In other environment examples, evolution of fire across a territory given certain weather conditions, human victim behaviour given certain external stimulus, etc, can be modelled. The forward planning approximator first needs to be trained and tested with real environment transitions.

The environment model is a pre-built motor that generates a set of next states and rewards for a given environment transition (predicted non-controllable environment dynamics, current joint states, and swarm actions). It is directly dependent on human-expert reward function. The environment model can be responsible for simulating MDP transitions based on his own state-action approximator. The environment model's output can be directly related to the probabilistic behaviour model's output. This can allow each agent to perform decentralised simulated planning without team information exchange, thereby enhancing system robustness.

Algorithm parameters can also be defined at step 202. These can include step size parameter (learning rate), policy and planning steps for each agent. Each agent can have different attributes (e.g. depending on the mission/operation), although the detailed embodiment described herein is based on uniform algorithm criterion. In this case, ε-greedy policies are used on every agent to balance exploration and exploitation, i.e. agents act greedily according to its environment representation (state-action values), but every small probability e, agents perform a random action to explore the search space.

However, other policies may be used in alternative embodiments, including any policy that properly balances exploration and exploitation of the search space to achieve an optimal behaviour, e.g. optimistic initial values (for a problem with negative rewards, optimistic initial values will encourage the agents to explore the entire search space before converging to an optimal policy, not applicable in infinite search spaces). Another example is Upper-Confidence Bound (UCB), which uses a confidence interval to explore, i.e. state-action visits depend on state-action values plus an uncertainty term that is progressively reduced as the agent visits that particular or similar state-action pairs. Other examples include Soft-max distribution policies (policy parametrisation methods) that act based on action preferences, which can initially be set arbitrarily, and a function approximator method can learn the correct parametrisation after gaining experience (in contrast to v-greedy policy, soft-max distribution can reach a deterministic behaviour, i.e. an optimal action selection mechanism that progressively stops exploring after gaining experience). For continuous action spaces, probability distributions such as Gaussian can be employed, where the policy is defined as “the normal probability density over a real-valued scalar action, with mean and standard deviation given by parametric function approximators that depend on the state(s). Step size parameter α needs to be tuned before starting to learn. A hyperparameter analysis can be carried out, evaluating swarm performance for different learning rates.

Learning MDP sequences is conventionally done in learning episodes. Step 204 represents the start of a loop of steps performed for a learning episode. An episode is a series of states, actions, and rewards. It ends when terminal joint states are reached, i.e. when the swarm achieves the mission goal (e.g. payload delivery, enemy capture, victim rescue, etc), or when the agents arrive at a non-desired and irreversible scenario (e.g. vehicle collision). To summarise, MDP sequences produce episodes, and episodes are used to train the swarm of agents. At the beginning of each episode, states are initialised. In the example of a vehicle combat or SAR operation, vehicles may start from a specific point in space (basement). To encourage search space exploration, vehicles can be randomly initialised.

Step 206 represents the start of a loop of steps used for simulation. During this process each agent selects “fictitious” actions to simulate how it, and the other agents in the swarm, would act based on a state of the environment. These fictitious actions are not actually performed in the real environment, but data regarding which actions were selected is stored in order to gain knowledge that is then used to make enhanced selections of actions in the real environment. To see the swarm outcome, the embodiment executes the steps as shown in FIG. 2 agent-by-agent. In practical embodiments, each autonomous agent is independent and has its own computational module. Therefore, the steps within this loop can be considered as being performed simultaneously.

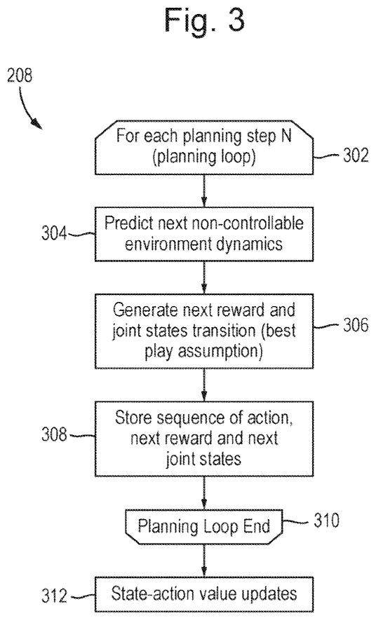

Step 208 is a forward planning routine. As mentioned above, all steps within the “swarm loop” steps 206-212 are repeated for every agent, including the forward planning routine 208, which is detailed in FIG. 3.

In FIG. 3 step 302 represents the start of a loop of N planning steps. N is usually linked to computational resources. Sometimes, there are many trajectories to consider, and hardware allows only few forward planning steps. More planning steps involve greater anticipation and thus, faster learning. Each agent predicts the next non-controllable environment state using its own probabilistic behaviour model at step 304. Embodiments can manage without swarm communication to increase robustness, i.e. there is no communication between agents. This can be beneficial in environments with poor communications infrastructure, low bandwidths, etc. Notwithstanding, there are two requirements that arise when sacrificing inter-agent communication. First, the agents need to have full MDP observability, that is, each autonomous agent needs to know on a real-time basis the location of its swarm mates, as well as all environment features (e.g. current fire state, enemy UAS positions, etc.). Agent locations can be obtained through estimates based on on-board sensor readings, which can be accurate enough in controlled and relatively small environments. Combinations of ground sensors can be used as well, but would entail a certain degree (basic) form of communication between station and agents. The second requirement lies in the swarm action assumptions that each agent needs to take to predict the next full environment transition. However, inter-agent communication can be used in other embodiments.

At step 306 each agent selects a fictitious action, using its own state-action selector (e.g. a value table in a tabular setting or function approximator) according to its (e.g. greedy) policy, that the agent itself would perform given the joint states. Further, each agent, again making use of the own state-action selector, effectively imagines being in its current swarm mates' situation and assumes their next best fictitious action. Thence, a best play assumption is defined as the agent acting greedily, following its policy when imagining scenarios from current swarm mates. Therefore, from a decentralised perspective, each agent uses its state-action selector (table/function) to decide what “best actions” will be taken by the whole swarm in the next fictitious planning steps. Next environment transitions can be computed if and only if these type of assumptions are taken. This mechanism can lead to forward planning disagreements between agents, but is part of the learning process. Such differences can lead each agent to explore different regions of the search space, and that can be translated into a global swarm balance. For real precision tasks (such as combat or rescue manoeuvres), communication layers may be added to achieve a better decentralised swarm coordination.

After selecting fictional actions for all agents in the swarm, at step 306 each agent also uses its environment model to return the next reward for each agent, and transitions to the next environment joint states. The action, next reward, and next joint states sequence is stored at step 308 for later state-action value updates. These may be stored as an MDP sequence comprising the selected actions of the agents, the reward for performing the selected actions and a next state to which the agent transitions by performing the selected action. The planning loop ends at step 310 when step N is reached, or when terminal joint states are given.

Subsequently, at step 312, corresponding RL returns are computed, and state-action values are updated back to the initial planning step, which is the real current time step.

This combination of the probabilistic behaviour model and the environmental model generates fictitious and prioritised samples that are directly related to the current real environment state (in contrast to conventional model planning with random or prioritised sampling based on TD error). This leads not only to faster learning rates, but also to greater anticipation from the agent's perspective.

Returning to FIG. 2, at step 210, following their policies and individual sources of knowledge (state-action value tables or function approximators), every agent selects an enhanced best action in the real environment thanks to the forward planning stage, anticipating to the environment.

Step 212 represents the end of the “swarm loop” of steps started at 206.

At step 214, after executing all real swarm actions, the environment transitions to the next real joint states, and every intelligent system/agent receives the corresponding reward. This MDP sequence is temporarily stored for direct RL updates.

At step 216 each autonomous system/agent leverages real gathered experience (environment transitions) to make direct state-action value updates.

Step 218 represents the end of the “episode loop” of steps started at 204. The steps in the loop are therefore repeated until episode termination. There can be as many learning episodes as required (normally episodes end after policy convergence, i.e. until optimal/suboptimal behaviours are achieved).

At step 220, the training process ends and each agent in the swarm can use the trained RL data to select and perform an action. For instance, if the selected action is to set the throttle to a particular value then a control signal can be sent from the processor 104 of the agent 102 to a propulsion controller of the vehicle to increase/decrease its throttle.

There follows a description of an embodiment based on an algorithm applied to the known Hunter-Pursuit cooperative game against intelligent evaders. The N-Step Dynamic Tree Search can aim to adapt the most successful single-agent learning methods to the multi-agent boundaries and demonstrates to be a remarkable advance compared to conventional temporal-difference techniques. The Hunter-Pursuit game, which involves a number of learning agents cooperating to capture one or more evaders, has been a reference to MARL nearly since its inception. It conceives a grid world with two learning hunters and an intelligent prey that tries to escape from chasers given their position. It will be appreciated that example embodiments can be produced that control autonomous vehicles in accordance with actions selected using the Hunter-Prey problem, or variations thereof.

A theoretical foundation in MARL is provided below, including MDPs, TD methods and the NSDTS algorithm.

### Markov Decision Process

MDPs are mathematical formalisms that codify the problem of one or more agents interacting with the environment. Nonetheless, there are minor differences between single-agent and multi-agent frames. In the MARL configuration, for a given time t and a set of n agents in Sₜ=(Sₜ⁰, Sₜ¹, . . . , Sₜⁿ⁻², Sₜⁿ⁻¹) joint states, after executing Aₜ=(Aₜ⁰, Aₜ¹, . . . , Aₜⁿ⁻², Aₜⁿ⁻¹) actions through some action selection mechanism, the environment transitions all agents to the next MDP state Sₜ₊₁=(Sₜ⁰, Sₜ₊₁¹, . . . , Sₜ₊₁ⁿ⁻², Sₜ₊₁ⁿ⁻¹) and gives Rₜ₊₁ joint rewards to every learning agent. Each cycle represents an MDP step, and episodes are a collection of step sequences such <S₀, A₀, R₁, S₁, A₁, . . . , R_{T-1}, S_{T-1}> that at time t=T reach a terminal joint state.

The goal of RL agents is to maximize long-term rewards. Thus, a balance must be struck between instant gratification and protracted implications of acts. A common approach to solving this dilemma is to use the expected discounted sum of future rewards (1), also referred as return

$${G}_{t} \dot{=} {R}_{t + 1} + γ {R}_{t + 2} + {γ}^{2} {R}_{t + 3} + ⋯ = {\sum }_{k = 0}^{∞} {γ}^{k} {R}_{t + k + 1} ; \qquad ( 1 )$$

with Gₜ expected return at time step t and γ discount factor affecting future terms. It is worth noting that (1) is a finite geometric progression if 0≤γ≤1.

MDP features are defined by problem conditions. Sensor constraints, environmental circumstances or simply experimental settings prevent agents from fully noticing joint states in Partially Observable Markov Decision Processes (POMDPs). Factored MDPs (FMDPS) promote parallel processing via state aggregation and abstraction. Embodiments are based on a fully-observable MDP, i.e. agents have complete knowledge all current states without restrictions.

### Temporal-Difference Methods

TD techniques are contained in the sample-based learning gamut. State-action value estimates Qⁱ(Sₜ, Aₜⁱ) are used to numerically quantify the execution of certain action Aₜⁱ in Sₜ joint states at t time step by any i agent. Each intelligent agent computes, stores, updates and uses its own estimates in tables (tabular setting) to improve decision making.

$${Q}^{i} ( {S}_{t} , {A}_{t}^{i} ) ← {Q}^{i} ( {S}_{t} , {A}_{t}^{i} ) + α [ {\hat{G}}_{t}^{i} - {Q}^{i} ( {S}_{t} , {A}_{t}^{i} ) ] \qquad ( 2 )$$

Commonly represented in sample-based learning, the incremental update rule (2) uses G\hat{ }ₜⁱ return estimate as the target of the update, from which the old state-action value is subtracted forming the TD error. Notice that α step size parameter, also known as learning rate, moderates the influence of the error in the equation.

Inspired by the recursive form of Bellman equations, TD methods define the return as a succession of state-action values. For a given policy πⁱ (agent behaviour), the Bellman state-action function, i.e., expected return given state s and action a, is characterized

$${q}_{π}^{i} ( s , a ) \dot{=} {E}_{{π}^{i}} [ {G}_{t}^{i} \vert {S}_{t} = s , {A}_{t}^{i} = a ] = {\sum }_{{s}^{′}} {\sum }_{r} p ( {s}^{′} r \vert s , a ) [ {r}^{i} + γ {\sum }_{{a}^{′}} {π}^{i} ( {a}^{′} \vert {s}^{′} ) {q}_{π}^{i} ( {s}^{′} , {a}^{′} ] . \qquad ( 3 )$$

Environment dynamics ρ, also seen as the probability of transitioning to next joint states s′ and receive rⁱ reward given s and a, are often unknown. Consequently, ρ term is usually enclosed in α learning rate (2), which is tuned through hyperparameter analysis.

Given s′, the expectation term in (3), bootstraps the likelihood of selecting next action multiplying it by its respective state-action value. While Expected SARSA return is defined as in (3), SARSA employs the next state-action value Qⁱ_{t,π}(Sₜ₊₁, Aⁱₜ₊₁), and Q-Learning exploits the maximum state-action value maxQⁱ(Sₜ₊₁, a′). Off-policy methods such Expected SARSA and Q-Learning can adopt exploratory behaviours without affecting state-action value updates, a powerful technique to balance exploration and exploitation. On-policy methods instead, require specific policies like E-greedy (see Sutton, R. S. and Barto, A. G. (2018) Reinforcement Learning: An introduction) to achieve that equilibrium. Embodiments can use an ε-greedy policy for every agent.

### N-Step Dynamic Tree Search

As a tree search algorithm, NSDTS incorporates forward planning mechanisms and real-world updates. Let model-based learning be decomposed in two submodules: a probabilistic behaviour model and an environment model. The first is responsible for forecasting future evader movement patterns based on current joint states Sₜ. The latter determines Sₜ₊₁ joint states transition by greedily selecting action Aⁱₜ assuming best play of team agents. After N future samples, updates are backpropagated until the root node of the tree. The estimated return for N forward steps is presented in (4):

$${\hat{G}}_{τ : τ + N}^{i} = {R}_{τ + 1}^{i} + γ {\sum }_{a \neq {A}_{τ + 1}^{i}} {π}^{i} ( a \vert {S}_{τ + 1} ) {Q}_{τ + N - 1}^{i} ( {S}_{τ + 1} , a ) + {γπ}^{i} ( {A}_{τ + 1}^{i} \vert {S}_{τ + 1} ) {\hat{G}}_{τ + 1 : τ + N} \qquad ( 4 )$$

Note the difference between real time t and forward fictitious time T. According to TD incremental update rule in (2). Qⁱ table is first refreshed at τ+N−1 time step, thence the subscript. Furthermore, for τ+1=N and τ+1=T special cases, where τ=min (T, t+[0, 1, . . . , N−1]), the estimated return is computed either an expected TD update

$${\hat{G}}_{τ}^{i} = {R}_{τ + 1}^{i} + γ {\sum }_{a} {π}^{i} ( a \vert {S}_{τ + 1} ) {Q}^{i} ( {S}_{τ + 1} , a ) , \qquad ( 5 )$$

or just G\hat{ }ⁱ_{τ}=Rⁱ_{T} respectively. Equation (5) coincides with Expected SARSA return; therefore, state-action values are counterbalanced with πi probability distribution. Note that (4) is the multi-step version of (5).

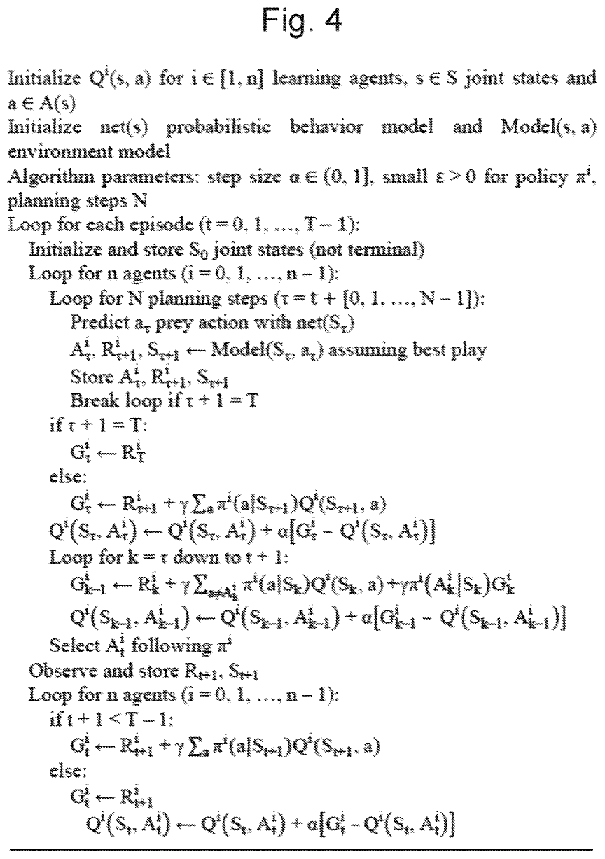

Once model-learning stage ends, agent i gains real-world experience through the enhanced policy πⁱ. The full NSDTS algorithm is disclosed step-by-step in FIG. 4. It will be appreciated that although the specific example of FIG. 4 relates to the Hunter-prey problem, the skilled person will be able to modify it for other applications, such as controlling autonomous vehicles or robots, especially in view of the previous discussion. The N-Step Dynamic Tree Search can improve agent policies and learning rates by integrating future sample trajectories and direct updates.

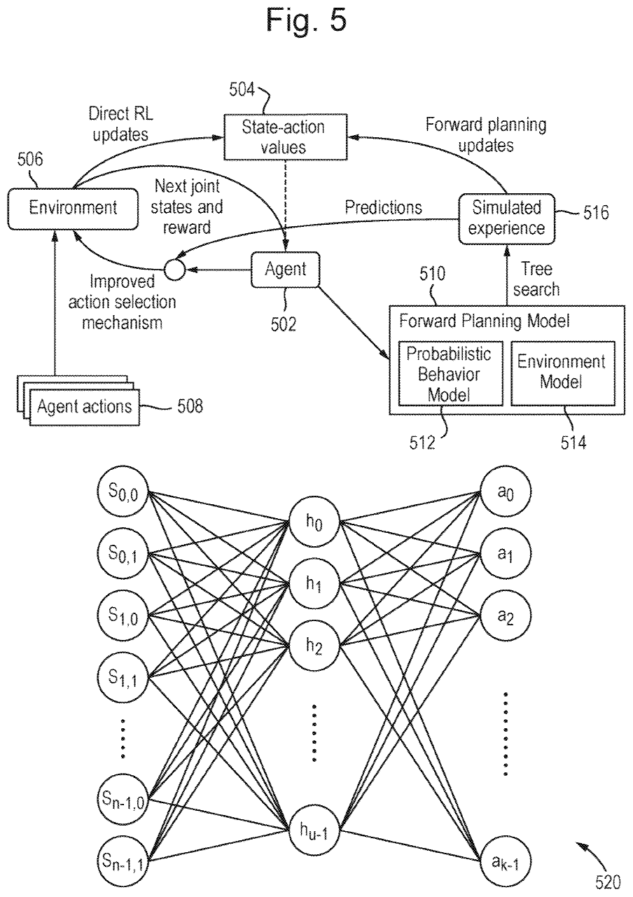

FIG. 5 discloses an example of the architecture of the system. Each agent 502 (only one is shown in the Figure for clarity) can access, check or update values within its decentralized state-action selector, e.g. Q table 504, to either execute forward planning or simply select a greedy action. The MDP is fully observable, i.e. each agent detects all joint state transitions from the environment 506. However, actions 508 taken by team agents are individually assumed and hence may differ from actual behaviours. Despite the apparent imbalances, these assumptions imply system robustness. Swarming enhancements via data exchange and team agreements figure in future work.

The agent 502 is provided with a forward planning model 510, which comprises the probabilistic behaviour model 512 and the environment model 514. These can be used to perform a tree search that results in simulated experience 516 that is used for forward planning updates to values in the state-action selector 504.

The probabilistic behaviour model comprises a neural network that predicts the evader's next action given Sₜ joint states. Network configuration is depicted at 520. The approximator has twice as many input neurons as joint MDP states, corresponding to the cartesian decomposition of the environment. The number of hidden neurons u remains a hyperparameter, while the output layer is constituted by the available actions k that an agent can execute Neural Network design may vary depending on the environment representation.

As aforementioned, the probabilistic behaviour model forecasts next prey actions based on a resulting probability distribution. This can also be thought as a classifier problem, with an assortment of MDP states as the input, and several action classes the output. Thereupon, the error of prediction is computed through a cross entropy function. Optimization can be implemented via backpropagation using ADAM (Kingma. D. P. and Ba, J. (2014) ‘Adam: A Method for Stochastic Optimization’, 3rd International Conference on Learning Representations, ICLR 2015 —Conference Track Proceedings, pp. 1-15. Available at: http://arxiv.org/abs/1412.6980). This upgraded version of Stochastic Gradient Descent (SGD) leverages adaptive vector step sizes, ergo, greater learning rates for parameters with higher errors, and low-order moments that progressively boost weight gradients towards constant directions. Altogether, these techniques improve approximator learning processes reaching global or local minimums faster.

On the other hand, the environment model is responsible for simulating the next joint states transition based on the probabilistic behaviour model's output. Within this step, each agent computes its next fictitious action and assumes its teammates' fictitious action/moves, which are deducted from its own state-action value approximator. Thus, every agent can plan without team information exchange, thereby enhancing system robustness.

There now follows a discussion of key aspects and fundamental rules that characterize embodiments with regards to the Hunter-Prey pursuit problem, including environment features, game rules, and reward function.

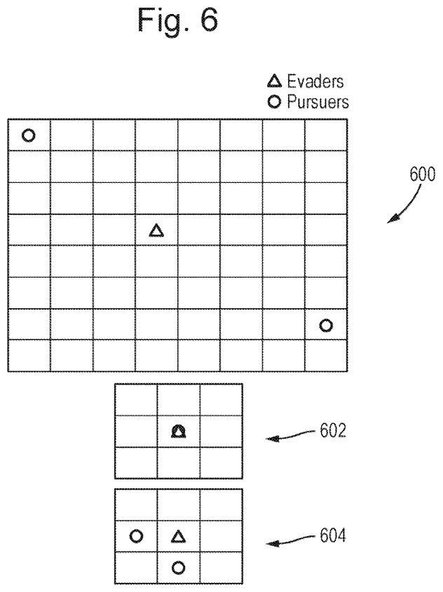

FIG. 6 shows an 8 by 8 grid world 600 with an evader and two intelligent pursuers, totaling 1,310,729 MDP states in the given representation. The prey is placed in the centre of the grid at the start of each episode, whereas hunters are randomly assigned to non-terminal states. Pursuers must capture the evader without colliding. Individual captures (illustrated at 602) occur when a hunter and a prey occupy the same cell, while cooperative captures (illustrated at 604) arise when two or more pursuers are in the evader's closest adjacent cells. To encourage cooperation, captures involving multiple team agents receive higher rewards. Collisions, on the other hand, happen either when two or more hunters occupy the same cell, or if a hunter on the grid's edge conducts an action towards the wall. Agents engaged in a crash are penalized. Furthermore, to encourage hunting efficiency, pursuers are given a negative compensation each time step. Each agent can move up, right, down, and given the occasion, stay on the same cell.

Embodiments were used to evaluate the performance of hunters against an intelligent prey that, following an E-greedy policy, moves away from hunters given their position. If the evader is cornered and no possible escape actions are available, the agent randomly selects an action.

There now follows example results and discussion of hyperparameter analysis and the algorithm. Since algorithm performance is deeply dependent on α learning rate, a hyperparameter analysis is carried out first to tune a for each method. The table below summarizes the setup configuration adopted for an experiment:

| | |
|---|---|
| Algorithm Parameters | |
| Planning steps (N) | 5 |
| Discount factor (γ) | 1.00 |
| Exploring parameter (ε) | 0.10 |
| Model Features | |
| Input units | 6 |
| Hidden units | 8 |
| Output units | 5 |
| Neural network learning rate | 10⁻³ |
| Weight decay (λ) | 10⁻³ |
| Mean moment update parameter (βm) | 9 · 10⁻² |
| Second moment update parameter (βv) | 9.99 · 10⁻² |
| Batch size | 500 |
| Training samples | 25,000,000 |
| Testing samples | 5,000,000 |
| Model accuracy | 81.4% |
| Hybrid Reward Function | |
| Colliding with boundaries or other agents | −100 |
| Each step | −1 |
| Individual captures | +10 |
| Cooperative captures | +100 × n_{c} |

Algorithm parameters were applied to all methods in the experiment except from N planning steps that only apply to NSDTS. Neural network learning rate (not to be confused with a from RL algorithms) influences the weight gradient size towards a loss function's minimum, while λ is utilized to avoid overfitting. Adaptive vector step sizes and low order moments of ADAM optimizer are regulated by the mean moment update βₘ and second moment update βᵥ. A total of 25 and 5 million samples have been used to train and test the neural network model, achieving a model accuracy of 81.4% despite the randomness involved in ε-greedy evader's policy. As far as the reward function is concerned, a hybrid structure, i.e. a combination of individual and global rewards, has been carefully designed to approach the credit assignment problem, where n_{c} refers to the number of pursuers involved in the cooperative capture.

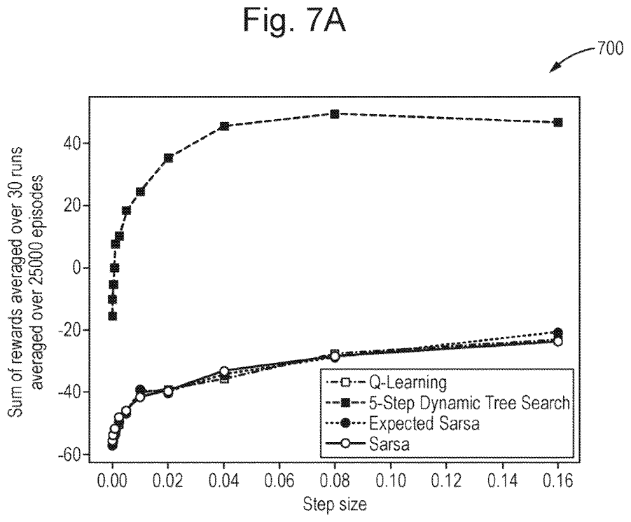

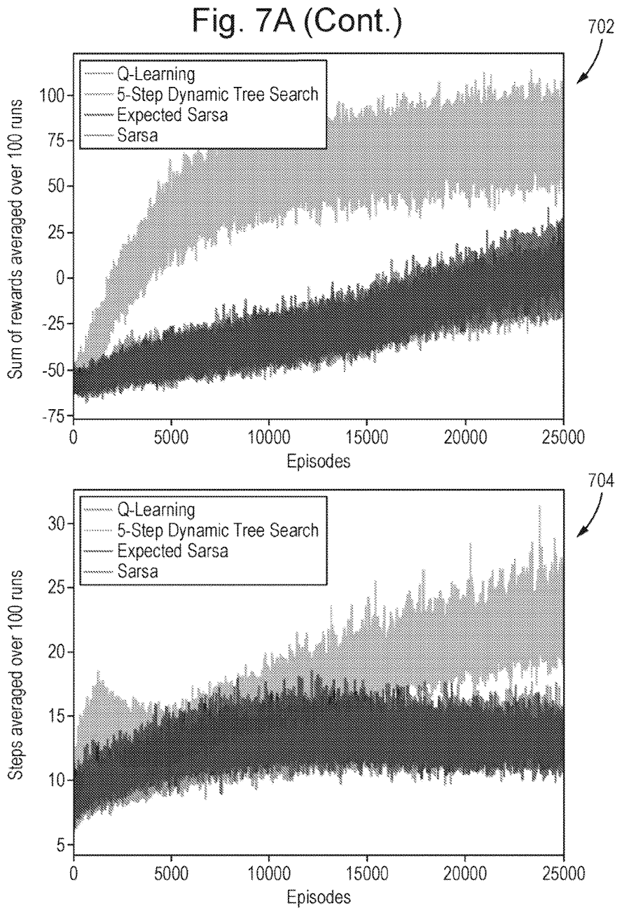

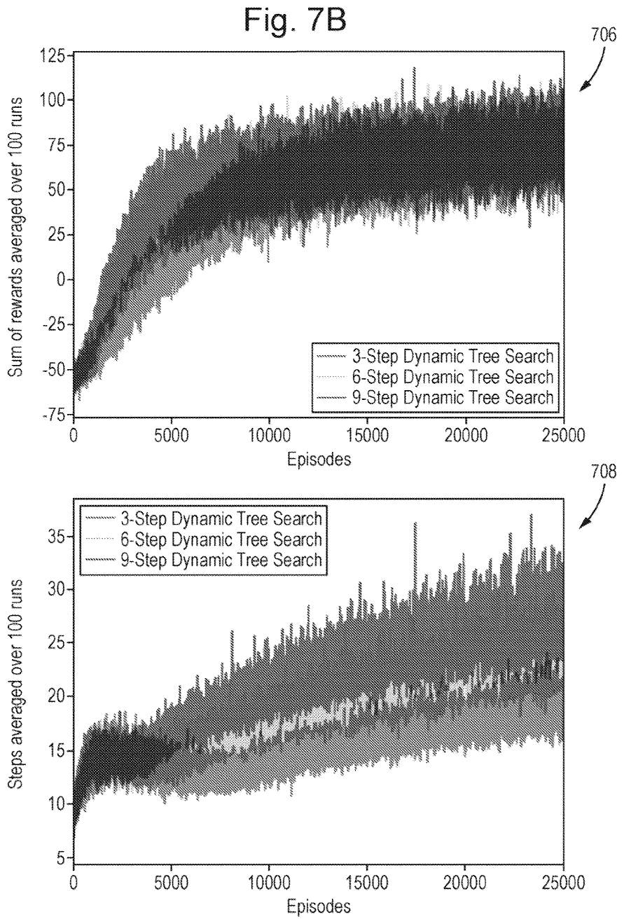

Hyperparameter analysis results in the graphs of FIGS. 7A-7B already show the difference between NSDTS and other TD methods. Experiments evaluated the performance of N-Step Dynamic Tree Search against Q-Learning, Expected SARSA and SARSA temporal-difference methods. The Figure shows a learning rate hyperparameter analysis (700), and measures performance based on averaged sum of rewards (702) and averaged steps (704). The impact of forward planning steps is displayed at 706 and 708 as averaged sum of rewards and steps respectively.

After 25,000 episodes, for a learning rate α=0.080, 5-Step Dynamic Tree Search overall performance is more than 50 times better than the rest, which represents an improvement greater than 5000%. Additionally, performance based on the averaged sum of rewards demonstrates that tree search achieves greater learning rates. After 10,000 episodes, 5SDTS nearly converged to the optimal policy, while conventional TD methods fail to reach a suboptimal policy in 25,000 episodes. Introducing an intelligent evader significantly increases the complexity of the problem and search space. Therefore, algorithms such as Q-Learning require more training to converge.

It is worth noting that at the end of the performance analysis, NSDTS develops successfully cooperative policies due to the remarkable high reward. Nevertheless, it takes more steps to reach a terminal state. The combination of expected updates and forward planning allow agents to avoid collisions and choose actions conservatively, resulting in higher rewards at expense of longer episodes. Likewise, a higher number of forward planning steps results in greater cumulative rewards. Longer tree search reasoning allows agents to learn at faster rates and avoid complex states that heavily compromise agent performance, i.e. situations where collisions can easily arise without communication. For the given environment, few forward steps are required to reach optimal performance after convergence. However, an increasing problem complexity may require additional planning steps to reach optimal policies.

Embodiments can be based on the N-Step Dynamic Tree Search, which can evaluate future joint states based on an inferred model learned from real-world interactions. Embodiments have been shown to achieve not only a striking performance, but also incredibly high learning rates. NSDTS presents an improvement superior to 5000% with respect to Expected SARSA, Q-Learning and SARSA, both after policy convergence and as overall performance. Thus, embodiments represent a significant advance in the multi-agent domain compared to conventional MARL techniques. The experimentation was carried out within the hunter-prey pursuit framework, under a decentralized tabular setting and without information exchange between team agents.

It will be understood that the embodiments described herein can be implemented using any suitable software applications, programming language, data editors, etc, and may be represented/stored/processed using any suitable data structures, and so on.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A computer-implemented method of controlling components associated with a swarm of agents by controlling the swarm of agents to perform actions, the method comprising:
providing data for performing reinforcement learning in each agent in the swarm;
each of the agents in the swarm using the provided data to execute at least one learning episode to train a respective state-action selector in each of the agents in the swarm, wherein the state-action selector is configured to select an action based on joint states of the agents in the swarm; and
each of the agents in the swarm using its respective trained state-action selector to select and perform an action and sending a control signal corresponding to the selected action to a said component associated with the agent;
wherein the reinforcement learning comprises a Markov decision process (MDP), and the provided data includes data for performing the MDP and includes
the state-action selector,
a policy for determining how to use the state-action selector to select the action based on the joint state of the agents, the policy comprising an ε-greedy policy,
a probabilistic behaviour model configured to predict a next state of an environment based on a current state of the environment, wherein the probabilistic behaviour model comprises an artificial neural network configured to predict next actions of non-controllable items/features in the environment given current joint states of the agents, and
an environment model configured to generate a set of next joint states of the agents and rewards, based on the current state of the environment, the current joint states of the agents, and current actions of the agents in the swarm; and
wherein the training of the respective state-action selector in each of the agents in the swarm includes
using the probabilistic behaviour model to predict the next state of the environment,
each of the agents in the swarm using its respective state-action selector to select a fictitious action it would perform itself in the current joint states and to select a fictitious action other agents in the swarm would perform in the current joint states,
using the environment model to generate a next reward and a next joint states transition of the agents based on the predicted next state of the environment,
storing an MDP sequence comprising the selected fictitious actions, the next reward, and the next joint state transition, and
using the selected fictitious actions to update values in the state-action selector of each of the agents in the swarm.

2. The method according to claim 1, comprising:
computing reinforcement learning returns, and
updating values in the state-action selector back to a real current time step.

3. The method according to claim 2, comprising:
each of the agents in the swarm using its respective policy and its respective state-action selector to select an action to perform in the feel-environment;
transitioning the environment to the next state, providing a corresponding reward to each of the agents in the swarm, and storing an MDP sequence to update values in the state-action selectors; and
each of the agents in the swarm using the stored MDP sequence to update the values in its respective state-action selector.

4. The method according to claim 1, wherein the state-action selector comprises a state-action value table or a state-action function.

5. The method according to claim 1, wherein the agents do not perform inter-agent communication, but have full MDP observability.

6. (canceled)

7. The method according to claim 1, wherein the artificial neural network is configured to function as a classifier that receives as input MDP states, and outputs action classes.

8. The method according to claim 7, wherein error prediction of the artificial neural network is computed using a cross entropy function, and the artificial neural network is optimized via backpropagation.

9. An agent apparatus comprising a processor and a memory, wherein the processor is configured to perform the method according to claim 1.

10. The agent apparatus according to claim 9, wherein the agent apparatus is in, or on, or associated with, a vehicle capable of autonomous behaviour, or a robot.

11. A system comprising a swarm of the agent apparatus according to claim 9.

12. A computer program product comprising one or more non-transitory machine readable mediums encoded with instructions which, when executed by one or more processors, cause a process to be carried out for controlling components associated with a swarm of agents by controlling the swarm of agents to perform actions, the process comprising:
providing data for performing reinforcement learning in each agent in the swarm:
each of the agents in the swarm using the provided data to execute at least one learning episode to train a respective state-action selector in each of the agents in the swarm, wherein the state-action selector is configured to select an action based on joint states of the agents in the swarm; and
each of the agents in the swarm using its respective trained state-action selector to select and perform an action and sending a control signal corresponding to the selected action to a said component associated with the agent;
wherein the reinforcement learning comprises a Markov decision process (MDP), and the provided data includes data for performing the MDP and includes
the state-action selector,
a policy for determining how to use the state-action selector to select the action based on the joint state of the agents, the policy comprising an ε-greedy policy,
a probabilistic behaviour model configured to predict a next state of an environment based on a current state of the environment, wherein the probabilistic behaviour model comprises an artificial neural network configured to predict next actions of non-controllable items/features in the environment given current joint states of the agents, and
an environment model configured to generate a set of next joint states of the agents and rewards, based on the current state of the environment, the current joint states of the agents, and current actions of the agents in the swarm; and
wherein the training of the respective state-action selector in each of the agents in the swarm includes
using the probabilistic behaviour model to predict the next state of the environment,
each of the agents in the swarm using its respective state-action selector to select a fictitious action it would perform itself in the current joint states and to select a fictitious action other agents in the swarm would perform in the current joint states,
using the environment model to generate a next reward and a next joint states transition of the agents based on the predicted next state of the environment,
storing an MDP sequence comprising the selected fictitious actions, the next reward, and the next joint state transition, and
using the selected fictitious actions to update values in the state-action selector of each of the agents in the swarm.

13. The computer program product according to claim 13, the process comprising:
each of the agents in the swarm using its respective policy and its respective state-action selector to select an action to perform in the environment;
transitioning the environment to the next state, providing a corresponding reward to each of the agents in the swarm, and storing an MDP sequence to update values in the state-action selectors; and
each of the agents in the swarm using the stored MDP sequence to update the values in its respective state-action selector.

14. The computer program product according to claim 12, wherein the state-action selector comprises a state-action value table or a state-action function.

15. The computer program product according to claim 12, wherein the agents do not perform inter-agent communication, but have full MDP observability.

16. The computer program product according to claim 12, wherein the artificial neural network is configured to function as a classifier that receives as input MDP states, and outputs action classes.

17. The computer program product according to claim 16, wherein error prediction of the artificial neural network is computed using a cross entropy function, and the artificial neural network is optimized via backpropagation.

18. A computer program product comprising one or more non-transitory machine readable mediums encoded with instructions which, when executed by one or more processors, cause a process to be carried out for controlling an agent to perform actions, the agent included in a swarm of agents and includes a state-action selector that is trained to select an action based on joint states of the agents in the swarm, the process comprising:
selecting and performing, by the agent included in the swarm of agents and using its trained state-action selector, an action; and
sending, by the agent included in the swarm of agents, a control signal corresponding to the selected action to a component associated with the agent included in the swarm of agents;
wherein the state-action selector is trained using reinforcement learning, and the reinforcement learning comprises a Markov decision process (MDP).

19. The computer program product according to claim 18, wherein data for performing the MDP includes:
the state-action selector;
a policy for determining how to use the state-action selector to select the action based on the joint state of the agents, the policy comprising an e-greedy policy;
a probabilistic behaviour model configured to predict a next state of an environment based on a current state of the environment, wherein the probabilistic behaviour model comprises an artificial neural network configured to predict next actions of non-controllable items or features in the environment given current joint states of the agents; and
an environment model configured to generate a set of next joint states of the agents and rewards, based on the current state of the environment, the current joint states of the agents, and current actions of the agents in the swarm;

20. The computer program product according to claim 19, wherein training the state-action selector includes:
using the probabilistic behaviour model to predict the next state of the environment;
the agent included in the swarm of agents using its state-action selector to select a fictitious action it would perform itself in the current joint states and to select a fictitious action other agents in the swarm would perform in the current joint states;
using the environment model to generate a next reward and a next joint states transition of the agents based on the predicted next state of the environment;
storing an MDP sequence comprising the selected fictitious actions, the next reward, and the next joint state transition; and
using the selected fictitious actions to update values in the state-action selector of the agent included in the swarm of agents.

21. The computer program product according to claim 20, the process comprising:
each of the agents in the swarm using its respective policy and its respective state-action selector to select an action to perform in the environment;
transitioning the environment to the next state, providing a corresponding reward to each of the agents in the swarm, and storing an MDP sequence to update values in the state-action selectors; and
each of the agents in the swarm using the stored MDP sequence to update the values in its respective state-action selector.
